(19) United States
(12) Patent Application Publication
(10) Pub. No.: US 2024/0419954 A1
(43) Pub. Date: Dec. 19, 2024

(54) SYSTEM AND METHOD FOR NEURAL NETWORK STRUCTURE-LEVEL QUANTIZATION OPTIMIZATION

(71) Applicant: Black Sesame Technologies Inc., San Jose, CA (US)

(72) Inventor: Peng Zan, Gaithersburg, MD (US)

(73) Assignee: Black Sesame Technologies Inc., San Jose, CA (US)

(21) Appl. No.: 18/209,932

(22) Filed: Jun. 14, 2023

(51) Int. Cl. G06N 3/063; G06N 3/0495

(52) U.S. Cl. CPC G06N 3/063; G06N 3/0495

(57) ABSTRACT

Embodiments of this disclosure provide a system and method for reducing quantization errors at an output of a hardware device functioning as a neural network structure. During operation, the system can obtain type information associated with the neural network structure and construct a hardware model of the neural network structure based on the obtained type information, the hardware model comprising one or more paths for performing arithmetic operations. The system can formulate an optimization problem to reduce the quantization errors based on the constructed hardware model, the optimization problem being defined by an objective function and a set of constraints. The system can solve the optimization problem and configure the hardware device based on a solution to the optimization problem, thereby reducing the quantization errors at the output of the hardware device.

### RELATED APPLICATIONS

This disclosure is related to U.S. patent application Ser. No. 18/081,515, Attorney Docket No. BST-180, entitled “SYSTEM AND METHOD FOR MATHEMATICAL MODELING OF HARDWARE QUANTIZATION PROCESS,” by inventor Peng Zan, filed 14 Dec. 2022, the disclosure of which is incorporated herein by reference in its entirety for all purposes.

### BACKGROUND

### Field

The disclosed embodiments generally relate to the quantization of neural network parameters. More specifically, the disclosed embodiments relate to using an optimization technique to improve neural network quantization accuracy.

### Related Art

Deep neural networks (DNNs) have been widely used in AI-enabled edge devices such as autonomous driving chips, home security systems, and autonomous robots, among others. However, due to the large model size of the DNNs and the limited computational power associated with edge computing devices, there is an increasing demand for techniques that can reduce the DNN model size and decrease power consumption without significantly compromising the inference speed. Note that improvements in the inference speed and power efficiency can also reduce cloud-infrastructure costs and would make it possible to run these computational tasks on heterogeneous devices such as smartphones, internet-of-things devices, and on various types of low-power hardware.

Some existing attempts to achieve the above-combined objectives include building lightweight models using a bottom-up approach and reducing the model size by using a combination of quantization, pruning, and compression techniques. However, when deploying the above models to edge devices, such as application-specific integrated circuit (ASIC)-based devices, they often experience decreased model accuracies because hardware-specific algorithmic operations and limitations on these devices can impose constraints on the quantization process of the deployed models.

### SUMMARY

Embodiments of this disclosure provide a system and method for reducing quantization errors at an output of a hardware device functioning as a neural network structure. During operation, the system can obtain type information associated with the neural network structure and construct a hardware model of the neural network structure based on the obtained type information, the hardware model comprising one or more paths for performing arithmetic operations. The system can formulate an optimization problem to reduce the quantization errors based on the constructed hardware model, the optimization problem being defined by an objective function and a set of constraints. The system can solve the optimization problem and configure the hardware device based on a solution to the optimization problem, thereby reducing the quantization errors at the output of the hardware device.

In a variation on this embodiment, the hardware device can include at least a multiplier or an accumulator, an adder, and a number of bit-shifting units.

In a further variation, the bit-shifting units can include a set of right bit-shifting units and a set of left bit-shifting units, and the objective function is to minimize a weighted sum of bit shifts of the set of right bit-shifting units.

In a further variation, a weight factor associated with a right bit-shifting unit is inversely correlated with a distance between the right bit-shifting unit and an input stage of the hardware device.

In a further variation, the set of constraints can include at least a set of hardware constraints based on sizes of the bit-shifting units and a set of operation-specific constraints comprising at least a first equality constraint between quantization scales of inputs of an adder and a second equality constraint between quantization scales of input and output of a path for performing arithmetic operations.

In a further variation, solving the optimization problem can include performing a brute-force search in a search space defined by the hardware constraints.

In a variation on this embodiment, the neural network structure can include one of: a single-path residual block, a multi-path-with-concatenation residual block, and a residual block with multiple pruning channels.

### DESCRIPTION OF THE FIGURES

FIG. 1 illustrates a generalized hardware implementation of a single-path residual network with convolution and add nodes, according to one embodiment of the instant application.

FIG. 2 illustrates an exemplary hardware implementation of a simple residual block, according to one embodiment of the instant application.

FIG. 3 demonstrates an exemplary algorithm for optimizing the hardware configurations of a single-path residual block, according to one embodiment of the instant application.

FIG. 4 illustrates an exemplary hardware implementation of a residual network with multiple concatenated residual paths, according to one embodiment of the instant application.

FIG. 5 illustrates an exemplary hardware implementation of a pair of concatenated residual blocks, according to one embodiment of the instant application.

FIG. 6 demonstrates an exemplary algorithm for optimizing the hardware configurations of a multi-path-with-concatenation residual block, according to one embodiment of the instant application.

FIG. 7 illustrates an exemplary hardware implementation of a residual network with pruning channels, according to one embodiment of the instant application.

FIG. 8 demonstrates an exemplary algorithm for optimizing the hardware configurations of a residual block with pruning channels, according to one embodiment of the instant application.

FIG. 9 presents a flowchart illustrating an exemplary process for optimizing the hardware configurations of a neural network structure, according to one embodiment of the instant application.

FIG. 10 illustrates an exemplary computer system that facilitates the optimization of the hardware configurations of a neural network structure, according to one embodiment of the instant application.

In the figures, like reference numerals refer to the same figure elements.

### DETAILED DESCRIPTION

The following description is presented to enable any person skilled in the art to make and use the disclosed embodiments and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

### Overview

Embodiments of this disclosure provide a system and method for mathematical modeling and optimization of the quantization of neural network parameters and output on edge computing devices, e.g., application-specific integrated circuit (ASIC)-based mobile devices that contain multiplier-accumulator (MAC) units or MAC arrays. Within an edge device, these MAC units or arrays are configured to perform both neural network parameter quantization (or simply “neural network quantization”) and neural network model execution, layer by layer, through multiplications, additions, and bit-level manipulations. Physical limitations of the customized hardware (e.g., size, power consumption, etc.) can impose various constraints on the quantization process, which can decrease the quantization accuracy.

The disclosed systems and techniques can be used to establish a mathematical model of the hardware quantization operations. More specifically, the quantization process can be formulated as an optimization problem with constraints imposed by the actual hardware. Optimal hardware parameters (e.g., parameters that can minimize quantization errors) can be determined by solving the optimization problem. Because smaller quantization scales for algorithmic operations can result in higher precision, the objective function of the optimization problem can be minimizing operations leading to larger quantization scales. In some embodiments, the MAC array can use bit-shift operations to change the quantization scale, with the right shifts for increasing the quantization scale. Accordingly, the objective function can be minimizing the right-shift bit number subject to various constraints, which can include hardware-induced constraints. In situations where multiple right shifts occur in one path, the objective function can be minimizing the weighted sum of the right shifts.

Residual blocks are the fundamental building blocks of a neural network (NN). In some embodiments, the system can optimize the hardware configurations for three types of residual blocks, including single-path residual blocks, multi-path-with-concatenation residual blocks, and residual blocks with pruning. Various techniques can be used to solve the optimization problems. In one embodiment, an exhaustive-search technique can be used to solve the optimization problems.

### Neural Network Quantization

Neural network (NN) quantization, which is a process of converting high-precision floating point numbers (e.g., 32-bit floating point numbers) into low-bit-depth integer representations (e.g., 8-bit signed integer or int8 numbers), can significantly reduce the NN model size before deployment to edge devices, thereby reducing memory and computational resource requirements, and power consumption. For example, when quantizing weights of a NN model from the 32-bit floating-point scheme to the 8-bit fixed-point scheme, the model size can be reduced by a factor of 4. Generally speaking, various NN quantization techniques can be classified into (1) post-train quantization (PTQ), where quantization is performed on a model after model training; and (2) quantization-aware training (QAT), where quantization processes are embedded into a neural network and the model is trained in conjunction with the quantization process. In comparison, the PTQ approach is generally easier to implement, whereas the QAT approach tends to have higher model accuracy because of the retraining process.

A basic feature of a quantization scheme is that it permits efficient implementation of a wide range of arithmetic operations using only integer arithmetic operations on the quantized values. In other words, the quantization scheme is an affine mapping of integers q to real numbers (including floating point values) r based on the following linear transformation scheme:

$$r = s * ( q - z ) , \qquad ( 1 )$$

wherein s and z are constant values further described below. Note that Equation (also referred to as “Eqn.” below) 1 provides a quantization scheme, wherein q is the quantized value, and the constants s and z are the quantization parameters. For per-tensor quantization, the quantization scheme uses a single set of quantization parameters for all values within each activations array and each weights array. Meanwhile, separate arrays use separate quantization parameters.

For 8-bit quantization, q is quantized as an 8-bit integer (for B-bit quantization, q is quantized as a B-bit integer). Some arrays, such as bias vectors, can be quantized as 24-bit or 32-bit integers.

The parameters (also referred to as the “scale” or the “quantization scale”) can be a positive real number. Generally speaking, scale s can be used to define a floating-point range that corresponds to a single binary bit in the quantized value representation. Scale s can also be viewed as a linear mapping coefficient that maps an integer value q to the corresponding floating-point value r. Scale s also dictates the resolution of the above linear mapping, whereas a smaller value of scale s corresponds to a higher resolution of the linear mapping. Note that scale s is typically represented in software as a floating-point quantity, similar to the real values r. The parameter z (also referred to as the “zero-point” or the “bias”) is of the same numeric type as the quantized value q and can be regarded as the quantized value q corresponding to the real value 0. This designation allows the quantization scheme to provide that real value r=0 be represented by a quantized value. The motivation for this feature is that efficient implementation of neural network operators often requires zero-padding of arrays around boundaries.

The quantization parameters (including scale s and bias z) can be obtained using the PTQ or QAT scheme. When the PTQ scheme is used, the process of estimating s and z can include a calibration process. In contrast, when the QAT scheme is used, the process of estimating s and z can be based on retraining a floating-point network. Given a set of quantization parameters for each layer in a neural network, the quantized value q for any given input real value r can be derived from Eqn. 2 below:

$$\hat{q} = clip ( ⌊ r / s ⌉ , N , P ) + z \qquad ( 2 )$$

wherein the operator around the quantity r/s performs a rounding-to-the-nearest integer operation, and the “clip” operator takes the rounded integer after rounding of r/s and clips/fits the rounded value within the range specified by bounds N and P. For B-bit signed integers, N=−2^{B-1} and P=2^{B-1}−1 are the lower and upper bounds of the integer representation, respectively. For unsigned integers, the values for N and P are N=0 and P=2^{B}−1, respectively. For example, with int8 (signed) representation, N=−128, and P=127 for signed integers. Note that to reduce the incidences of actually clipping a rounded value, a process referred to as “calibration” can be first performed on a calibration dataset before the quantization process, which is configured to determine a range (i.e., both the minimum value and the maximum value) for the input floating-points numbers which is then used to determine the proper scale s in Eqn. 2. For example, if the calibrated floating-point number range is [−1, 1], the scale s=2⁻⁷, as calculated by dividing the floating range with the integer range, i.e., 2/2⁸. As a result, the actual input values during the quantization process can largely fall within the predefined bounds of N and P. In various embodiments, the calibration dataset is collected from the outputs (i.e., activations) of all the layers (except the final layer) of a given neural network to achieve the maximum coverage of the possible activation data value range. However, clipping can still occur during the actual quantization operation because the calibration dataset may not always cover the actual data range during the actual quantization operation. Therefore, when performing algorithmic operations such as additions and multiplications on the quantized integers, the system can perform the same operations on the dequantized values in the floating-point domain, as shown in Eqn. 3,

$$\hat{r} = s * ( \hat{q} - z ) . \qquad ( 3 )$$

### Hardware Implementation of Residual Structures

Residual Neural Network (ResNet) is a deep learning model in which the weight layers learn residual functions with reference to the layer inputs. ResNet has been widely used in classification and object detection tasks, which can be essential for computer vision and autonomous driving applications. A deep residual network can be constructed by stacking a series of residual blocks, with each residual block comprising a subnetwork with a certain number (e.g., two or three) of stacked layers.

A typical residual block can include a number of convolution (Conv) and addition (Add) nodes. A convolution node can multiply an input tensor with weights in an accumulated manner and then add bias per channel to the results. Such operations can be implemented in hardware using a systolic array, or more specifically a MAC array. To support the residual block in the MAC array, one can use an add operation to each MAC unit. Note that the addition of two fixed-point tensors with per-tensor quantization scales would require the alignment of mantissa points.

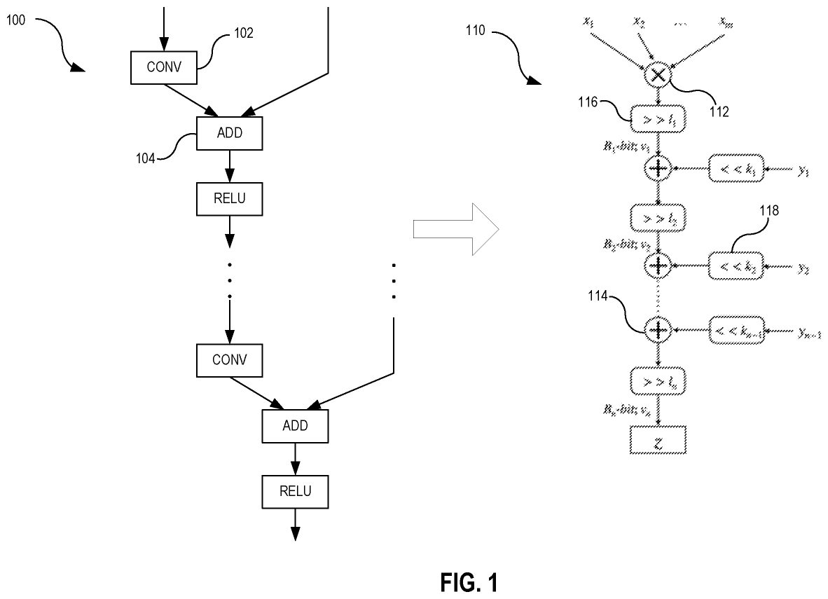

FIG. 1 illustrates a generalized hardware implementation of a single-path residual network with convolution and add nodes, according to one embodiment of the instant application. The left drawing shows the block diagram of a residual block 100 with a number of convolution nodes (e.g., Conv node 102) and add nodes (e.g., add node 104). The right drawing shows the hardware implementation of residual network 100 as a MAC array 110 that includes a multiplication unit 112 and a number of add units (e.g., add unit 114). The hardware implementation can also be referred to as a hardware model, which can include the necessary hardware components for performing the intended functions of the modeled neural network structure. MAC array 110 can also include a number of bit-shifting units (e.g., right bit-shifting unit 116 and left bit-shifting unit 118) for modifying the quantization scales. More specifically, right-shift by/bits (denoted >>l) can result in the quantization scale being upscaled by 2^{l}; whereas left-shift by k bits (denoted <<k) can result in the quantization scale being downscaled by 2^{k}.

In the example shown in FIG. 1, x₁, x₂ . . . xₘ are inputs of multiplication unit 112, y₁, y₂, . . . yₙ₋₁ are inputs to various add units, l₁, l₂ . . . lₙ are right shift bits, and k₁, k₂ . . . , kₙ₋₁ are left shift bits. Moreover, Bⱼ and vⱼ are signed integer bits and the maximum real-value in power-of-two, respectively, right after shift Iⱼ, ∀j∈1, . . . , n. z is the output.

A single convolution operation includes only one multiplication unit and one add unit. In such a case, the model of the hardware implementation can be simplified as m=2 and n=2, with x₁ representing the input tensor, x₂ representing the weight, and y₁ standing for the bias. For a residual block with the convolution layer and a child add node, the model can be simplified as m=2 and n=3, with x₁ and x₂ representing the activation input and weight, respectively, y₁ standing for the bias, and y₂ standing for the residual input.

Because the right bit-shifts can result in larger quantization scales and thus lower precision, the optimization problem becomes the problem of minimizing the bit numbers of the right shifts. In FIG. 1, the MAC hardware includes a main branch with a number of right shifts and a number of add branches, each with a left shift. The optimization variables can include the numbers of the bit-shifts, {l₁, l₂, . . . lₙ} for the main branch and {k₁, k₂ . . . , kₙ₋₁} for the add branches, given the quantization scales of inputs xᵢ, ∀ᵢ∈{1, . . . , m} and yⱼ, ∀ⱼ∈{1, . . . , n−1}, and output z.

In some embodiments, the quantization scales of x₁, x₂, . . . , xₘ can be denoted as sₓ_{₁}, sₓ_{₂}, . . . , sₓ_{ₘ}, respectively; the quantization scales of y₁, y₂, . . . , yₙ₋₁ can be denoted as s_{y}_{₁}, s_{y}_{₂}, . . . , s_{y}_{ₙ₋₁}, respectively; the quantization scale for the j^{th} addition operation can be denoted s_{A}_{ⱼ}, where j=1, 2, . . . , n−1; and the quantization scale of the output can be denoted s_{z}. Note that these quantization scales are deterministic and can be provided by either the QAT or the PTQ process. The optimization problem can be formulated as follows:

$${min}_{{l}_{1} , … , {l}_{n} , {k}_{1} , … , {k}_{n - 1}} n * {l}_{1} + ( n - 1 ) * {l}_{2} + … + {l}_{n} ; \qquad ( 4 a )$$

$$s . t . {\prod }_{i = 1}^{m} {s}_{{x}_{i}} * {2}^{{\sum }_{j = 1}^{n} {l}_{j}} = {s}_{z} ; \qquad ( 4 b )$$

$${\prod }_{i = 1}^{m} {s}_{{x}_{i}} * {2}^{{\sum }_{k = 1}^{j} {l}_{k}} = {s}_{{y}_{j}} * {2}^{- {k}_{j}} , j ∈ ( 1 , … , n - 1 \} ; \qquad ( 4 c )$$

$${s}_{{A}_{j}} = {s}_{{y}_{j}} * {2}^{- {k}_{j}} , j ∈ \{ 1 , … , n - 1 \} ; \qquad ( 4 d )$$

$${M}_{j} \leq {l}_{j} \leq {N}_{j} , {l}_{j} ∈ Z , j ∈ \{ 1 , … , n - 1 \} ; and \qquad ( 4 e )$$

$${P}_{j} \leq {k}_{j} \leq {Q}_{j} , {k}_{j} ∈ Z , j ∈ \{ 1 , … , n - 1 \} . \qquad ( 4 f )$$

In expression 4a, the right bit-shift values lⱼ are weighted based on the amount of impact of each lⱼ on the overall accuracy of quantization. Specifically, a right bit-shift operation performed closer to the input stage (i.e., having a smaller j) will have a higher impact on the quantization accuracy than another right bit-shift operation performed more downstream in MAC array 110, i.e., further away from the input stage. Therefore, the weight of each right bit-shift value can be inversely correlated with the distance between the shift registers and the input of MAC array 110. In one example, l₁, which has the largest impact on the overall quantization, is assigned the highest weight n. Similarly, l₂, which has the second largest impact on the overall quantization, is assigned the second highest weight n−1, and so on. Because a larger number of right shifts can lead to lower precision, the objective of the optimization is to minimize the weighted sum of the right bit-shifts (i.e., lⱼ's) of the entire quantization processes within MAC array 110, thereby obtaining the highest achievable accuracy of quantization. Note that regardless of the weighting scheme used in the objective function, the main goal of the corresponding optimization problem is to use as fewer right-shift bits as possible while searching for feasible solutions to the optimization problem. In one embodiment, the weight for each lⱼ can be determined by the value of j, with the weight for each lⱼ being n−j+1.

In addition to the objective function represented by expression 4a, the formulated optimization problem to obtain the highest achievable quantization accuracy also includes a set of formulated constraints. In various embodiments, these constraints can be classified into two categories: (1) hardware constraints related to the hardware resource limitations of the hardware implementing the MAC array; and (2) constraints dictated by the arithmetic operations. Eqns. 4b-4d and inequalities 4e-4f provide the formulations of these two categories of constraints that complement the objective function 4a to fully describe the optimization problem to be solved.

Eqn. 4b describes the relationship between the quantization scales {sₓ_{₁}, sₓ_{₂}, . . . , sₓ_{ₘ}} of inputs xᵢ and the quantization scale s_{z} of the final output z. In other words, Eqn. 4b specifies an equality constraint that must be satisfied by a valid solution to the optimization problem. More specifically, the constraint of Eqn. 4b requires that the quantization scale s_{z} of the final output z be equal to the sum of the quantization scales {sₓ_{₁}, sₓ_{₂}, . . . , sₓ_{ₘ}} of inputs {x₁, x₂, . . . , xₘ} while factoring in the total amount of the right bit-shifts {/1, . . . , In}.

Eqn. 4c is the constraint based on the equality requirement to the quantization scales of the two inputs of the n−1 addition operations. Eqn. 4c dictates that the two quantization scales associated with the two inputs at each of the add nodes should be equal to each other. Because there are n−1 add nodes in MAC array 110, there are n−1 corresponding equality constraints in Eqn. 4c. For example, when j=1, Eqn. 4c is reduced to

$${\prod }_{i = 1}^{m} {s}_{{x}_{i}} * {2}^{{l}_{1}} = {s}_{{y}_{1}} * {2}^{- {k}_{1}} ,$$

which is exactly the quantization-scale equality requirement for the first add node in MAC array 110. In another example, when j=2, Eqn. 13c is reduced to

$${\prod }_{i = 1}^{m} {s}_{{x}_{i}} * {2}^{{l}_{1} + {l}_{2}} = {s}_{y 2} * {2}^{- {k}_{2}} ,$$

which is exactly the quantization-scale equality requirement for the second add node in MAC array 110. Eqn. 4d is the constraint at the j^{th} add node when the quantization scale for the j^{th} addition output (i.e., s_{A}_{ⱼ}) is given. The quantization scales can be obtained via a calibration process, which is beyond the scope of this disclosure.

Inequalities 4e and 4f represent the constraints imposed by the hardware resources. More specifically, inequality 4e corresponds to the hardware-limited range of the right shifts, and inequality 4f corresponds to the hardware-limited range of the left shifts. A person skilled in the art can appreciate that the upper bounds of these hardware constraints are related to the maximum number of registers in the hardware available to perform the bit-shift operations. In most scenarios, the lower bound of the bit-shift values (e.g., Mⱼ and Pⱼ) can be 0. In certain special cases, the lower bound can be negative. Depending on the hardware implementation, the shift ranges can be the same or different for different j's.

The optimization problem expressed by 4a-4f can be simplified as follows:

$${min}_{{l}_{1} , … , {l}_{n} , {k}_{1} , … , {k}_{n - 1}} {\sum }_{j = 1}^{n} ( n - j + 1 ) * {l}_{j} ; \qquad ( 5 a )$$

$$s . t . {\sum }_{j = 1}^{n} {l}_{j} = {log}_{2} {s}_{z} - {\sum }_{i = 1}^{m} {log}_{2} {s}_{{x}_{i}} ; \qquad ( 5 b )$$

$${\sum }_{k = 1}^{j} {l}_{k} + {k}_{j} = {log}_{2} {s}_{{y}_{j}} - {\sum }_{i = 1}^{m} {log}_{2} {s}_{{x}_{i}} , j ∈ ( 1 , … , n - 1 \} ; \qquad ( 5 c )$$

$${k}_{j} = {log}_{2} {s}_{{y}_{j}} - {log}_{2} {s}_{{A}_{j}} , j ∈ \{ 1 , … , n - 1 \} ; \qquad ( 5 d )$$

$${M}_{j} \leq {l}_{j} \leq {N}_{j} , {l}_{j} ∈ Z , j ∈ \{ 1 , … , n - 1 \} ; and \qquad ( 5 e )$$

$${P}_{j} \leq {k}_{j} \leq {Q}_{j} , {k}_{j} ∈ Z , j ∈ \{ 1 , … , n - 1 \} . \qquad ( 5 f )$$

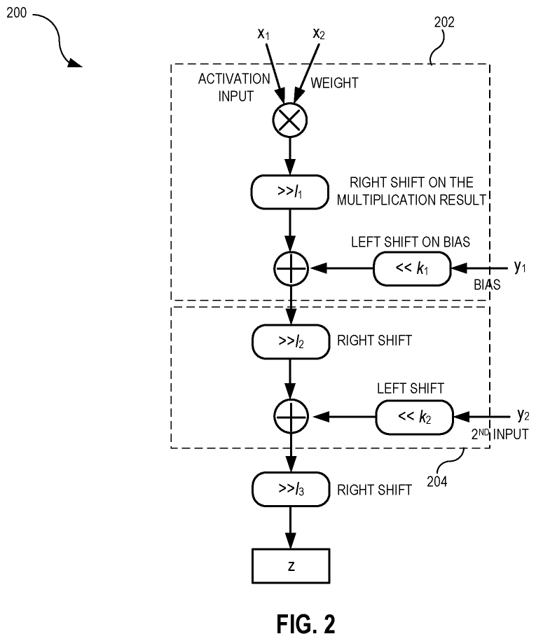

The optimization problem can be further simplified for a residual block that includes a convolution layer and an add layer. FIG. 2 illustrates an exemplary hardware implementation of a simple residual block 200, according to one embodiment of the instant application. In FIG. 2, residual block 200 includes a convolution layer 202 and an add layer 204. Inputs to the multiplication node of convolution layer 202 can include the activation input (x₁) and weight (x₂), and inputs to the add node of convolution layer 202 can include the multiplication result (x₁*x₂) and the bias (y₁). Before the addition operation, the multiplication result is right-shifted by l₁ bits, and the bias is left-shifted by k₁ bits. Inputs to add layer 204 can include the accumulated output of convolution layer 202 and a second input (y₂). Before they were added, the accumulated output of convolution layer 202 is right-shifted by l₂ bits, and the second input (y₂) is left-shifted by k₂ bits. The result of the addition is the right-shifted by l₃ bits as the final output of residual block 200.

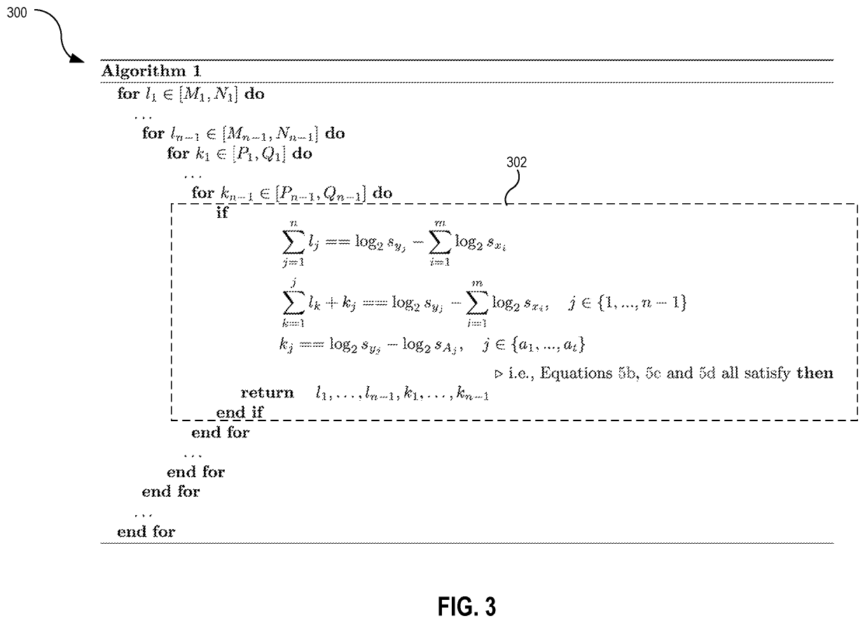

Various optimization techniques can be used to solve the optimization problem represented by 5a-5f. Considering that the number of shift registers included in a MAC unit is limited, the search space can be relatively small. In some embodiments, an exhaustive search (or brute-force search) can be performed. More specifically, the initial search space can be defined by the hardware constraints (i.e., inequalities 5e and 5f). FIG. 3 demonstrates an exemplary algorithm 300 for optimizing the hardware configurations of a single-path residual block, according to one embodiment of the instant application. As can be seen in FIG. 3, algorithm 300 can include a number of nested loops for performing the exhaustive search over the search space defined by the hardware constraints (i.e., inequalities 5e and 5f). Note that the objective function (e.g., the goal of minimizing the weighted sum of the right bit-shifts) can be reflected by the order of the search, which starts from the lowest bit-shift values for shift registers closest to the input stage (e.g., from l₁=M) and k₁=P₁). Note that the weight of each bit-shift value is reflected by the sequence of the loops. Bit-shifts that are further down the branch are in the inner loops. Note that the left shifts are not included in the objective function, and the left shift values are searched first. Operations in the most inner loop (i.e., loop 302) can be used to evaluate whether the current bit-shift values can satisfy the operation constraints defined by Eqns. 5b-5d. The output of algorithm 300 can include the optimized bit-shift values, including right shifts and left shifts, at each branch.

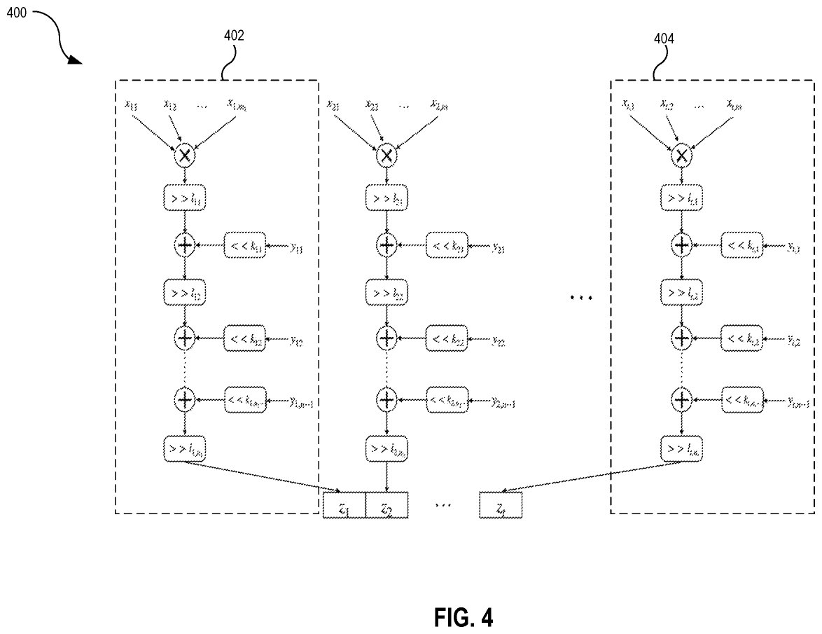

In addition to the single-path residual block, a similar hardware structure can be implemented for a concatenation node that includes multiple channels. FIG. 4 illustrates an exemplary hardware implementation of a residual network with multiple concatenated residual paths, according to one embodiment of the instant application. In FIG. 4, a residual network 400 can include multiple (e.g., t) residual paths, such as paths 402 and 404. The t residual paths can be concinnated at their output (e.g., z₁ . . . , zₜ). In this example, each residual path can be implemented using a MAC array similar to MAC array 110 shown in FIG. 1. As a result, the constraints for each path can be similar to the constraints applied to MAC array 110.

The optimization problem remains similar, which is to minimize the total number of right shifts in all branches. The optimization problem can be formulated as follows:

$${min}_{{{l}_{ij} , {k}_{ij}}_{{j ∈ \{ 1 , … , {n}_{j} \}}_{i ∈ \{ i , … , t \}}}} {\sum }_{i = 1}^{t} {\sum }_{j = 1}^{{n}_{i}} ( n - j + 1 ) * {l}_{ij} ; \qquad ( 6 a )$$

$$s . t . {s}_{{z}_{i}} = {s}_{{z}_{j}} , ∀ i \neq j , i ∈ \{ 1 , … , t \} , j ∈ \{ 1 , … , t \} ; \qquad ( 6 b )$$

$${\sum }_{j = 1}^{{n}_{i}} {l}_{ij} = {log}_{2} {s}_{{z}_{i}} - {\sum }_{i = 1}^{{m}_{i}} {log}_{2} {s}_{{x}_{ik}} , ∀ i ∈ \{ 1 , … , t \} ; \qquad ( 6 c )$$

$${\sum }_{k = 1}^{j} {l}_{ik} + {k}_{ij} = {log}_{2} {s}_{{y}_{ij}} - {\sum }_{k = 1}^{m} {log}_{2} {s}_{{x}_{ik}} , ∀ j ∈ ( 1 , … , n - 1 \} ; \qquad ( 6 d )$$

$${M}_{ij} \leq {l}_{ij} \leq {N}_{ij} , {l}_{ij} ∈ Z , ∀ j ∈ \{ 1 , … , {n}_{i} - 1 \} , i ∈ \{ 1 , … , t \} ; and \qquad ( 6 e )$$

$${P}_{ij} \leq {k}_{ij} \leq {Q}_{ij} , {k}_{ij} ∈ Z , ∀ j ∈ \{ 1 , … , {n}_{i} - 1 \} , i ∈ \{ 1 , … , t \} . \qquad ( 6 f )$$

Expression 6a indicates the objective function of the optimization problem, and Eqns. 6b-6d and inequalities 6e-6f are constraints on the variables (i.e., lᵢⱼ's and kᵢⱼ's) of the objective function. Eqn. 6b represents the tensor constraint. For per-tensor quantization, the concatenated tensor z=[z₁ . . . , zₜ] has a single quantization scale. Therefore, all input tensors of the concatenated nodes have the same quantization scale, as indicated by Eqn. 6b.

Eqn. 6c can be similar to Eqn. 5b and represent the input-output constraint for each path. More specifically, it describes the relationship between the input tensor scales and the output tensor scale of each path (e.g., the i^{th} path). Eqn. 6d can be similar to Eqn. 5c and can be based on the equality requirement to the quantization scales of the two inputs at each add node. Inequalities 6e and 6f can be similar to inequalities 5e and 5f, respectively, and can represent the hardware constraints on the shift registers (i.e., lᵢⱼ's and kᵢⱼ's). For each path (e.g., the i^{th} path), the inputs and output scales can be given, such as xᵢₖ, ∀k∈(1, . . . m); s_{z}_{ₜ}; and s_{y}_{ᵢⱼ}, ∀j∈(1, . . . nᵢ−1). These scales can be obtained via a calibration process, which is beyond the scope of this disclosure. The to-be-optimized variables can include lᵢⱼ and kᵢⱼ, ∀i, ∀j.

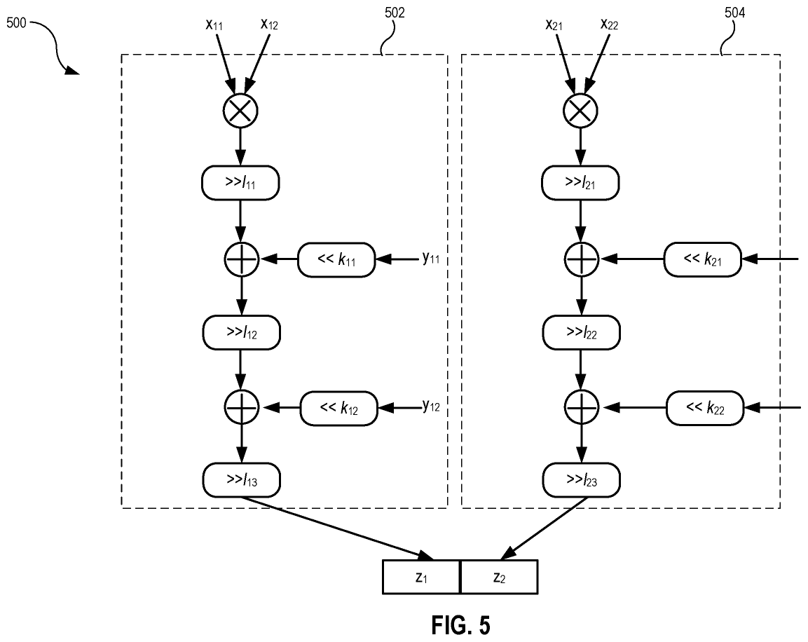

Many neural networks in computer-vision applications can include concatenated nodes with two inputs from two convolution outputs. In such a situation, the model can be simplified with mᵢ=2, nᵢ=3, ∀i, and t=2. FIG. 5 illustrates an exemplary hardware implementation of a pair of concatenated residual blocks, according to one embodiment of the instant application. In FIG. 5, a residual network 500 can include two concatenated paths, path 502 and path 504, with each path including a convolution layer and an add layer.

The hardware configuration optimization problem for the multi-path-concatenation residual blocks can be represented by objective function 6a and constraints 6b-6f. The goal is to minimize the weighted sum of right shifts by giving more weights to shifts closer to the input layer (i.e., a larger weight for a smaller j). The optimization problem can be solved using various techniques. In some embodiments, a brute-force or exhaustive search can be applied to determine the optimal solution.

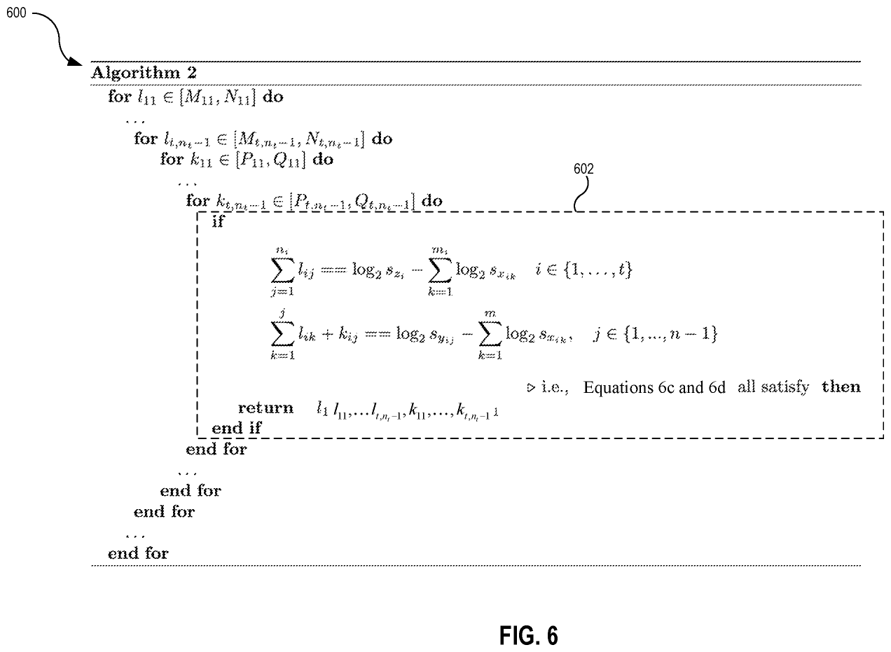

FIG. 6 demonstrates an exemplary algorithm 600 for optimizing the hardware configurations of a multi-path-with-concatenation residual block, according to one embodiment of the instant application. In the example shown in FIG. 6, algorithm 600 can include a number of nested loops for performing the exhaustive search over a search space defined by the hardware constraints (i.e., inequalities 6e and 6f). Like algorithm 300, the objective function of the optimization problem is reflected by the order of the search. Operations in the most inner loop (i.e., loop 602) can be used to determine whether a searched solution satisfies the operation constraints defined by Eqns. 6c-6d. The output of algorithm 600 can include the bit-shift values, including right shifts and left shifts, at each branch.

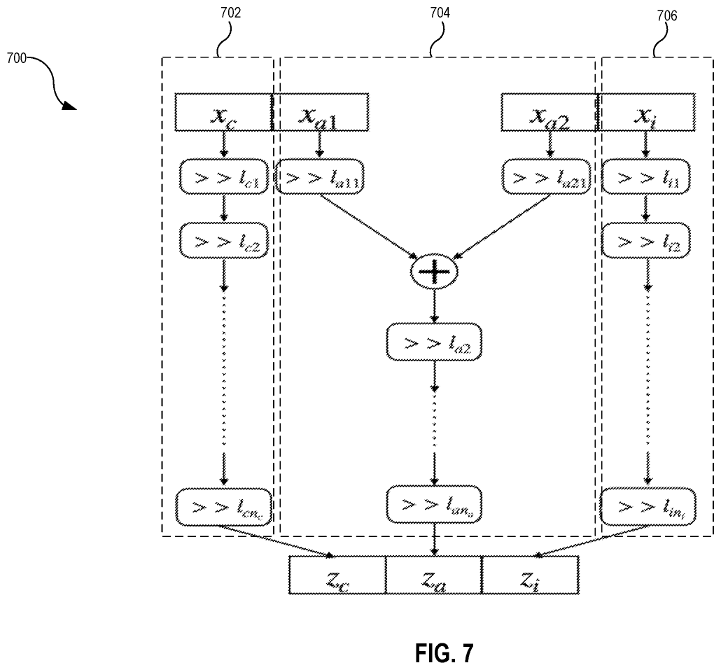

It is also possible to apply the same optimization principle to a convolution-add structure with pruning channels. FIG. 7 illustrates an exemplary hardware implementation of a residual network with pruning channels, according to one embodiment of the instant application. In FIG. 7, a residual network 700 can include multiple channels, including a copy channel 702, an add channel 704, and an insert channel 706. Pruning is an important way to achieve network sparsity and improve the runtime performance of the MAC arrays. During training, one or more channels can be selectively turned into zeros, thereby reducing the computational load of the residual block with pruning channels.

In the example shown FIG. 7, the feature map inputs of copy channel 702, add channel 704, and insert channel 706 are denoted as x_{c}, xₐ, and xᵢ, respectively; and the corresponding feature map outputs are denoted as z_{c}, zₐ, and zᵢ. The bit-shifts in copy channel 702, add channel 704, and insert channel 706 are denoted as l_{cj}, j∈{1, n_{c}}, lₐₖ, k∈{1, nₐ}, and lᵢₘ, m∈{1, nᵢ}, respectively, where n_{c}, nₐ, and nᵢ are the upper bounds of the bit-shifts constrained by hardware. Given that the quantization scales for x_{c}/xₐ₁, xₐ₂/xᵢ, and output z are denoted sₚ, s_{f}, and sₒ, respectively, the optimization problem can be expressed as follows:

$${min}_{{{{l}_{cj} , j ∈ \{ 1 , … , {n}_{c} \}}_{{l}_{a , k} , k ∈ \{ 1 , … , {n}_{a} \}}}_{{l}_{im} , m ∈ \{ 1 , … , {n}_{i} \}}} {\sum }_{j = 1}^{{n}_{c}} ( {n}_{c} - j + 1 ) * {l}_{cj} + {\sum }_{k = 1}^{{n}_{a}} ( {n}_{a} - k + 1 ) * {l}_{ak} + {\sum }_{m = 1}^{{n}_{i}} ( {n}_{i} - m + 1 ) * {l}_{i m} ; \qquad ( 7 a )$$

$$s . t . {l}_{a 1} = {l}_{a 11} + {l}_{a 21} ; \qquad ( 7 b )$$

$${s}_{p} * {2}^{{l}_{a 11}} = {s}_{f} * {2}^{{l}_{a 21}} ; \qquad ( 7 c )$$

$${s}_{p} * {2}^{{\sum }_{j = 1}^{{n}_{c}} {l}_{cj}} = {s}_{o} ; \qquad ( 7 d )$$

$${s}_{p} * {2}^{{l}_{a 11} + {\sum }_{k 2}^{{n}_{a}} {l}_{o k}} = {s}_{o} ; \qquad ( 7 e )$$

$${s}_{p} * {2}^{{\sum }_{m = 2}^{{n}_{i}} {l}_{im}} = {s}_{o} ; \qquad ( 7 f )$$

$${M}_{c} \leq {l}_{cj} \leq {N}_{c} , j ∈ \{ 1 , … , {n}_{c} \} ; \qquad ( 7 g )$$

$${M}_{a} \leq {l}_{a 11} , {l}_{a 21} \leq {N}_{a} ; \qquad ( 7 h )$$

$${M}_{a} \leq {l}_{ak} \leq {N}_{a} , k ∈ \{ 1 , … , {n}_{a} \} ; and \qquad ( 7 i )$$

$${M}_{i} \leq {l}_{im} \leq {N}_{i} , m ∈ \{ 1 , … , {n}_{i} \} . \qquad ( 7 j )$$

Expression 7a defines the objective function, and Eqns. 7c-7f and inequalities 7g-7j are constraints, including the constraints associated with the quantization scales and the constraints associated with the hardware resources (e.g., the upper and lower bounds of the number of shift registers).

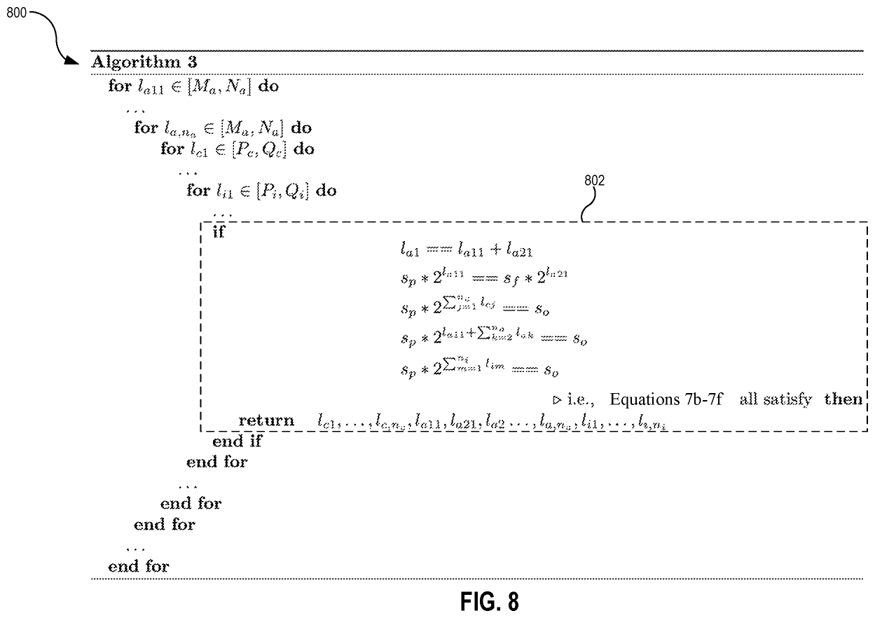

FIG. 8 demonstrates an exemplary algorithm 800 for optimizing the hardware configurations of a residual block with pruning channels, according to one embodiment of the instant application. In the example shown in FIG. 8, algorithm 800 can include a number of nested loops for performing the exhaustive search over a search space defined by the hardware constraints (i.e., inequalities 7g-7j). Like algorithm 300, the objective function of the optimization problem can be reflected by the order of the search. Operations in the most inner loop (i.e., loop 802) can be used to determine whether a search solution satisfies the operation constraints defined by Eqns. 7b-7f. The output of algorithm 800 can include the bit-shift values in each channel.

In general, depending on the type of neural network node or structure needing optimization of hardware configurations, three different optimization problems (e.g., the optimization problem for a single-path residual block described by 5a-5f, the optimization problem for a multi-path-with-concatenation residual block described by 6a-6f, and the optimization problem for a residual block with pruning channels described by 7a-6j) can be applied. Quantization accuracy can be improved by solving the optimization problem. More specifically, the number of bit shifts at each branch can be determined to minimize the total number of right shifts.

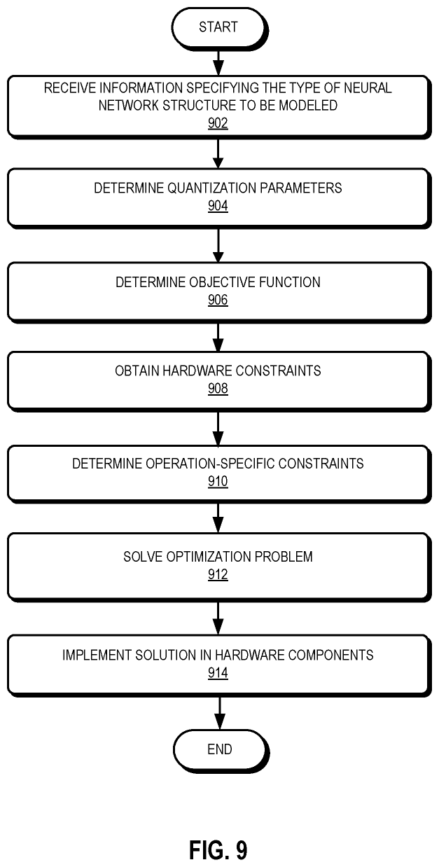

FIG. 9 presents a flowchart illustrating an exemplary process for optimizing the hardware configurations of a neural network structure, according to one embodiment of the instant application. In one or more embodiments, one or more of the steps in FIG. 9 may be repeated and/or performed in a different order. Accordingly, the specific arrangement of steps shown in FIG. 9 should not be construed as limiting the scope of the technique.

In various embodiments, the formulated optimization problem can include a set of optimizable variables, an objective function of the set of optimizable variables, and a set of constraints (which can include both equality and inequality constraints). Because the neural network structure is implemented by computer hardware, such as a group of MAC units, the optimization process can include the steps of constructing various components of the optimization problem based on the hardware operations (e.g., MAC register operations). In some embodiments, the optimizable variables can include the number of bit-shifts, including both the right bit-shifts and the left bit-shifts.

During operation, the system may receive information specifying the type of neural network structure to be optimized (operation 902). In some embodiments, the type information can include information about the number of paths or channels included in the structure. Exemplary neural network structures can include but are not limited to a single-path residual block, a multi-path-with-concatenation residual block, and a channel-pruning structure. In one embodiment, the single-path residual block can include a convolution layer (which comprise a multiplier and an adder) and one or more add layers (which comprise an adder). In one embodiment, the multi-path-with-concatenation residual block can include multiple concatenated paths, with each path being similar to a single-path residual block. In one embodiment, the channel-pruning structure can include concatenated copy channels, add channels, and insert channels.

Based on the type of neural network structure, the system can determine a set of quantization parameters (operation 904). More specifically, the quantization parameters can be determined based on a set of arithmetic operations to be performed by the neural network structure. The set of arithmetic operations can include but is not limited to multiplication, addition, bit-shift (both left-shift and right-shift), clipping, rounding, and other arithmetic operations. The set of quantization parameters can include a set of quantization scales, zero points, etc. The quantization scales can be obtained using a calibration process, such as a QAT process or a PTQ process.

The system can determine an objective function of the optimization problem aimed at improving the quantization precision at the output of the neural network structure, wherein the objective function includes a set of optimizable variables (step 906). For example, the objective function can be configured to minimize the quantization error by minimizing the total number of right bit-shifts in the neural network structure. In some embodiments, the set of optimizable variables can include a set of right bit-shift variables (e.g., {l₁, . . . , lₙ} in MAC array 110) and/or a set of left bit-shift variables (e.g., {k₁, . . . , kₙ₋₁} in MAC array 110), and the objective function can be formulated to minimize a weighted sum of the set of right bit-shift variables.

The system can obtain a set of hardware constraints (operation 908). The hardware constraints can be based on the sizes of the bit-shifting units (e.g., the number of shifter registers included in each bit-shifting unit, e.g., bit-shifting units 116 and 118). In some embodiments, the hardware constraints can be expressed using a number of inequalities (e.g., inequalities 4e and 4f).

The system can also determine additional operation-specific constraints based on the type of neural network structure, or more particularly, based on a set of arithmetic operations to be performed by the neural network structure (operation 910). The constraints can include quantization-scale equality constraints between the quantization scales of a set of input values of the neural network structure and the quantization scale of the final output of the neural network structure, wherein the neural network structure transforms the set of input values through a set of multiplications, additions, and bit-shifts. An example of these quantization-scale equality constraints was provided above in conjunction with Eqn. 4b. The constraints can also include quantization-scale equality constraints for the two inputs of each identified addition operation. An example of these quantization-scale equality constraints was provided above in conjunction with Eqn. 4c. Operations 904-910 can be collectively referred to as an optimization-model-construction process, in which a mathematic model of the hardware configuration optimization problem can be constructed for the neural network structure, the model comprising an objective function and a set of constraints.

The system can subsequently solve the optimization problem defined by the objective function and the constraints (operation 912). Various algorithms can be used to solve the optimization problem. In one embodiment, an exhaustive or brute-force search can be performed in a search space defined by the hardware constraints. More specifically, the objective function can be achieved by performing the search in a predefined sequence. For example, to achieve the goal of minimizing the total number of the right shifts, the search starts from the lower bound (e.g., zero) of the right shifts. Moreover, applying weight at each stage can also be achieved via arranging the search order in a way such that the bit-shift values of stages further away from the input stage are searched earlier (meaning that they are incremented earlier and hence are given smaller weights). The various quantization-scale equality constraints (e.g., Eqns. 5b-5d) can be checked in each search loop to make sure the searched solution meets the constraints. The solution to the optimization problem can include a set of optimized values for the set of adjustable variables/parameters (e.g., a set of hardware configurations) that minimizes quantization errors. In one example, the solution to the optimization problem for a single-path residual block (e.g., MAC array 110 shown in FIG. 1) can include a set of determined right bit-shifts (e.g., {l₁, . . . , lₙ}) that minimizes the weighted sum of the set of right bit-shifts and a set of determined left bit-shifts (e.g., {k₁, . . . , kₙ₋₁}).

After obtaining the optimized set of adjustable parameters (e.g., the bit-shifts) for the optimization problem, the system can implement the solution in corresponding hardware components (operation 914). In some embodiments, the system can configure the hardware device according to the optimized set of adjustable parameters. For example, the hardware device can include a number of bit-shifting units, and the bit-shift values (e.g., lⱼ's and kⱼ's in FIG. 1) before each adder in MAC array 110 can be applied to the bit-shifting units (e.g., by sending a set of instructions to each bit-shifting unit to configure the shift registers within each unit), thereby improving the quantization accuracy of the neural network structure during the operation of the neural network, including both the training process and the learning process. In some embodiments, the optimization process can be part of the machine-learning training process.

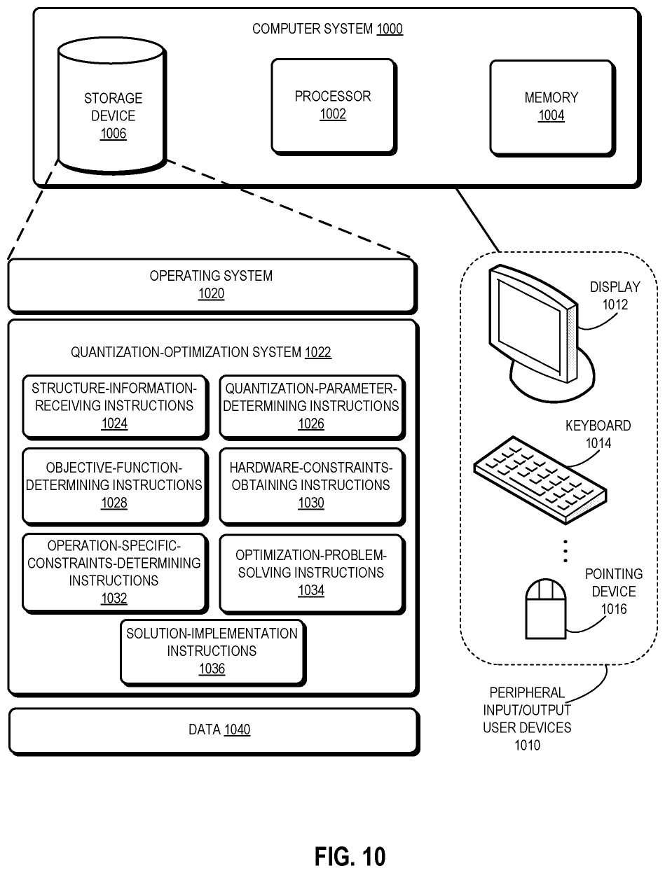

FIG. 10 illustrates an exemplary computer system that facilitates the optimization of the hardware configurations of a neural network structure, according to one embodiment of the instant application. Computer system 1000 includes a processor 1002, a memory 1004, and a storage device 1006. Furthermore, computer system 1000 can be coupled to peripheral input/output (I/O) user devices 1010, e.g., a display device 1012, a keyboard 1014, and a pointing device 1016. Storage device 1006 can store an operating system 1020, a quantization-optimization system 1022, and data 1040.

Quantization-optimization system 1022 can include instructions, which when executed by computer system 1000, can cause computer system 1000 or processor 1002 to perform methods and/or processes described in this disclosure. Specifically, quantization-optimization system 1022 can include instructions for receiving information about a to-be-modeled neural network structure (structure-information-receiving instructions 1024), instructions for determining the quantization parameters related to the to-be-modeled neural network structure (quantization-parameter-determining instructions 1026), instructions for determining the objective function (objective-function-determining instructions 1028), instructions for obtaining hardware constraints (hardware-constraints-obtaining instructions 1030), instructions for determining operation-specific constraints (operation-specific-constraints-determining instructions 1032), instructions for solving the optimization problem (optimization-problem-solving instructions 1034), and instructions for implementing the optimization solution in hardware (solution-implementation instructions 1036).

This patent disclosure presents various techniques to model neural network quantization processes on computing hardware such as a group of MAC units and to formulate and solve an optimization problem given a neural network structure. Different optimization problems can be formulated for different types of neural network structures, including a single-path residual block, a multi-path-with-concatenation residual block, and a channel-pruning structure. The optimization problem can be formulated to minimize quantization errors in each type of structure. The optimization problem can be defined by an objective function and a set of constraints, including the hardware constraints and the operation-specific constraints about quantization scales. The optimization problem can be solved using an exhaustive or brute-force search technique to search a parameter space defined by the hardware constraints. The system can subsequently implement the solution in the hardware device (e.g., by sending instructions to program the number of bit shifts in the bit-shift units), thus improving the quantization accuracy of the neural network structure during the training and learning processes.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices, solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the optimized parameters from the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processes included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A computer-implemented method for reducing quantization errors at an output of a hardware device functioning as a neural network structure, the method comprising:
obtaining type information associated with the neural network structure;
constructing a hardware model of the neural network structure based on the obtained type information, wherein the hardware model comprises one or more paths for performing arithmetic operations;
formulating an optimization problem to reduce the quantization errors based on the constructed hardware model, wherein the optimization problem is defined by an objective function and a set of constraints;
solving, by a computer, the optimization problem; and
configuring the hardware device based on a solution to the optimization problem, thereby reducing the quantization errors at the output of the hardware device.

2. The computer-implemented method of claim 1, wherein the hardware device comprises at least a multiplier or an accumulator, an adder, and a number of bit-shifting units.

3. The computer-implemented method of claim 2, wherein the bit-shifting units comprise a set of right bit-shifting units and a set of left bit-shifting units, and wherein the objective function is to minimize a weighted sum of bit shifts of the set of right bit-shifting units.

4. The computer-implemented method of claim 3, wherein a weight factor associated with a right bit-shifting unit is inversely correlated with a distance between the right bit-shifting unit and an input stage of the hardware device.

5. The computer-implemented method of claim 2, wherein the set of constraints comprises at least:
a set of hardware constraints based on sizes of the bit-shifting units; and
a set of operation-specific constraints comprising at least a first equality constraint between quantization scales of inputs of an adder and a second equality constraint between quantization scales of input and output of a path for performing arithmetic operations.

6. The computer-implemented method of claim 5, wherein solving the optimization problem comprises performing a brute-force search in a search space defined by the hardware constraints.

7. The computer-implemented method of claim 1, wherein the neural network structure comprises one of:
a single-path residual block;
a multi-path-with-concatenation residual block; and
a residual block with multiple pruning channels.

8. A non-transitory computer readable storage medium storing instructions which, when executed by a processor, causes the processor to perform a method for reducing quantization errors at an output of a hardware device functioning as a neural network structure, the method comprising:
obtaining type information associated with the neural network structure;
constructing a hardware model of the neural network structure based on the obtained type information, wherein the hardware model comprises one or more paths for performing arithmetic operations;
formulating an optimization problem to reduce the quantization errors based on the constructed hardware model, wherein the optimization problem is defined by an objective function and a set of constraints;
solving the optimization problem; and
configuring the hardware device based on a solution to the optimization problem, thereby reducing the quantization errors at the output of the hardware device.

9. The non-transitory computer readable storage medium of claim 8, wherein the hardware device comprises at least a multiplier or an accumulator, an adder, and a number of bit-shifting units.

10. The non-transitory computer readable storage medium of claim 9, wherein the bit-shifting units comprise a set of right bit-shifting units and a set of left bit-shifting units, and wherein the objective function is to minimize a weighted sum of bit shifts of the set of right bit-shifting units.

11. The non-transitory computer readable storage medium of claim 10, wherein a weight factor associated with a right bit-shifting unit is inversely correlated with a distance between the right bit-shifting unit and an input stage of the hardware device.

12. The non-transitory computer readable storage medium of claim 9, wherein the set of constraints comprises at least:
a set of hardware constraints based on sizes of the bit-shifting units; and
a set of operation-specific constraints comprising at least a first equality constraint between quantization scales of inputs of an adder and a second equality constraint between quantization scales of input and output of a path for performing arithmetic operation.

13. The non-transitory computer readable storage medium of claim 12, wherein solving the optimization problem comprises performing a brute-force search in a search space defined by the hardware constraints.

14. The non-transitory computer readable storage medium of claim 8, wherein the neural network structure comprises one of:
a single-path residual block;
a multi-path-with-concatenation residual block; and
a residual block with multiple pruning channels.

15. A computer system, comprising:
a processor; and
a storage device coupled to the processor, wherein the storage device storing instructions which, when executed by the processor, cause the processor to perform a method for reducing quantization errors at an output of a hardware device functioning as a neural network structure, the method comprising:
obtaining type information associated with the neural network structure;
constructing a hardware model of the neural network structure based on the obtained type information, wherein the hardware model comprises one or more paths for performing arithmetic operations;
formulating an optimization problem to reduce the quantization errors based on the constructed hardware model, wherein the optimization problem is defined by an objective function and a set of constraints;
solving the optimization problem; and
configuring the hardware device based on a solution to the optimization problem, thereby reducing the quantization errors at the output of the hardware device.

16. The computer system of claim 15, wherein the hardware device comprises at least a multiplier or an accumulator, an adder, and a number of bit-shifting units.

17. The computer system of claim 16, wherein the bit-shifting units comprise a set of right bit-shifting units and a set of left bit-shifting units, and wherein the objective function is to minimize a weighted sum of bit shifts of the set of right bit-shifting units.

18. The computer system of claim 17, wherein a weight factor associated with a right bit-shifting unit is inversely correlated with a distance between the right bit-shifting unit and an input stage of the hardware device.

19. The computer system of claim 16, wherein the set of constraints comprises at least:
a set of hardware constraints based on sizes of the bit-shifting units; and
a set of operation-specific constraints comprising at least a first equality constraint between quantization scales of inputs of an adder and a second equality constraint between quantization scales of input and output of a path for performing arithmetic operation.

20. The computer system of claim 19, wherein solving the optimization problem comprises performing a brute-force search in a search space defined by the hardware constraints.
